(19) United States
(12) Patent Application Publication
(10) Pub. No.: US 2007/0203434 A1
(43) Pub. Date: Aug. 30, 2007

(54) Medical bed with an exercising means

(76) Inventors: Min Woo Namgung, Incheon (KR); Dong Woo Namgung, Incheon (KR)

Correspondence Address: IPLA P.A., 3580 WILSHIRE BLVD., 17TH FLOOR, LOS ANGELES, CA, 90010, US

(21) Appl. No.: 11/572,104

(22) PCT Filed: Jul. 26, 2005
(86) PCT No.: PCT/KR05/02412

§ 371 Date: Jan. 12, 2007

(30) Foreign Application Priority Data
Aug. 25, 2004 (KR) 10-2004-0067049

(51) Int. Cl. A61H 1/02; A61H 1/00; A61H 5/00

(52) U.S. Cl. 601/24; 601/23; 601/33

(57) ABSTRACT

The invention relates to a medical bed with an exercising means. The frame of the invention comprises a fixed frame taking a predetermined longitudinal middle position, a frame for the upper body exercise, taking the position ahead of the fixed frame, this frame being able to erect and lie around a hinge by a driving means, and a frame for the lower body exercise, taking the position behind the fixed frame, this frame being able to fold and unfold around a hinge and again around a midway articulation by a driving means.

### FIELD OF THE INVENTION

The present invention relates to a medical bed with an exercising means and more particularly a medical bed with an exercising means wherein the rehabilitation and health of a patient, particularly a rehabilitation patient, can be maintained or improved, by providing a medical bed having the exercising means, with which the upper and lower parts of the body, the legs, the arms etc. of the patient can be moved naturally by means of a power device.

### BACKGROUND OF THE INVENTION

Generally, medical beds have a tendency of designing and developing with emphasis on the functionality and utility in consideration of favoring the sleep and rest in the condition of comfort and peace.

Ordinary medical beds are in the construction having only a flat cushion irrespective of the physical shapes and conditions of patients, so that pain may be caused on the areas of the waist etc. in the case of employing the beds for a long period of time.

Most patients take tranquility as the priority, so that they chose to lie for a long time. As a result, there are many cases where various parts of the body, for example, the upper part of the body, the lower part of the body, the legs, and the legs lack in exercise.

Particularly, in the case of the patients who need rehabilitation treatment, as they have difficulty in moving various parts of their bodies, the exercise of steadily moving the body is most important in rehabilitation but nevertheless most of the existing beds failed to meet this requirement.

Accordingly, there may be an urgent need for a medical bed having a means, which can provide a natural exercise for the treatment and health of the patients needing a long-term treatment and recuperation, particularly the rehabilitation patients who are immovable by themselves.

### SUMMARY OF THE INVENTION

The present invention is devised in consideration of the above-described problems.

Accordingly, the object of the invention is to provide a medical bed with an exercising means, wherein both the physical rehabilitation and the improvement in basic physical strength of a patient, particularly a rehabilitation patient are realized by taking naturally the exercises of raising the upper body or bending or stretching the knees, moving up and down the arms etc. on a bed.

Another object of the invention is to provide a medical bed with an exercising means, wherein the health of a patient can be kept and improved, by allowing patients in various conditions to take repeated exercises with ease on the bed, mainly through a simple modification of the structure of the bed frame.

### BRIEF DESCRIPTION OF THE DRAWINGS

FIGS. 1 and 2 are the front view and the plan view of a medical bed according to the invention.

FIG. 3 is the view for the structure and the operation of the frame for the upper body exercising through the cross section A-A of FIG. 2.

FIG. 4 is the view for the structure and the operation of the frame for the lower body exercising through the cross section B-B of FIG. 2.

FIG. 5 is the view for the structure and the operation of the knee exercising device through the cross section C-C of FIG. 2.

FIG. 6 is the view for the structure and the operation of the arm exercising device through the cross section D-D of FIG. 2.

### DETAILED DESCRIPTION OF THE INVENTION

According to an aspect of the invention, there is provided a medical bed including railings disposed at the front and rear as well as the left and right positions, a frame and a mat on the frame, wherein the frame comprises a fixed frame taking a predetermined longitudinal middle position, a frame for the upper body exercise, taking the position ahead of the fixed frame, this frame being able to erect and lie around a hinge by a driving means, and a frame for the lower body exercise, taking the position behind the fixed frame, this frame being able to fold and unfold around a hinge and again around a midway articulation by a driving means.

Preferably, the frame for the upper body exercise comprises a support frame in the rectangular form turnable around a hinge on one side, the frame having a prescribed area, an actuating bar member disposed under the support frame and rotatable through an axial member in contact with the frame, the actuating bar member lifting the support frame through rod members in tight contact with the underside of the support frame, an actuating rod member based on the screw for pulling and pushing the actuating bar member by extending and shortening its length, the actuating rod member being connected to the axial member of the actuating bar member through a hinge on one side and connected to the shaft of the motor on the other side, and a motor hinge-supported on the frame, the motor being connected to the screw of the actuating rod member.

Further, the above-described support frame includes further rollers mounted on the areas in contact with the rod members of the actuating bar member.

Preferably, the actuating rod member is regulatable to extend or shorten by two limit switches fixed on the frame, the interval between the two limit switches being variable, and a sensor rod formed on the cylinder of the actuating rod member, the sensor rod being to contact the limit switches.

Preferably, the frame for the lower body exercise comprises a support frame in the combined rectangular form having a certain area, the support frame being rotatable and foldable or stretchable around a hinge on one side and around a halfway articulation, an actuating bar member disposed under the support frame and rotatable through an axial member in contact with the frame, the actuating bar member lifting the support frame through rod members in tight contact with the underside of the support frame, an actuating rod member based on the screw for pulling and pushing the actuating bar member by extending and shortening its length, the actuating rod member being connected to the axial member of the actuating bar member through a hinge on one side and connected to the shaft of the motor on the other side, and a motor hinge-supported on the frame, the motor being connected to the screw of the actuating rod member.

Additionally, the above-described support frame includes further rollers mounted on the areas in contact with the rod members of the actuating bar member.

Preferably, the actuating rod member is regulatable to extend or shorten by two limit switches fixed on the frame, the interval between the two limit switches being variable, and a sensor rod formed on the cylinder of the actuating rod member, the sensor rod being to contact the limit switches.

The above-described frame preferably comprises a chain disposed longitudinally under the frame and a motor for driving the chain, a slider movable back and forth under the guidance of two parallel guide bars, the bottom of the slider being connected to the chain, and a feet resting rest positioned to a prescribed height above the frame and movable back and forth, the feet resting rest passing through the frame to combine detachably with the underlying slider.

In addition, the feet resting rest comprises a supporting board connected to a supporting body through a hinge and also connected to a supporting body through a bolt regulator so as to be able to adjust the inclination angle of the board, the patient's feet being to be put on the board, and a supporting body connected to the side of the slider.

Preferably, the knee exercising device is regulatable in its stroke of moving back and forth by two limit switches fixed on the frame, the interval between the two limit switches being variable, and a sensor rod formed on the side of the slider, the sensor rod being to contact the limit switches.

Still further, the above-described frame comprises two subsidiary frames erected vertically on opposite front ends of the frame, two chains disposed parallel vertically and combined to the sprockets, the sprockets mounted on the top and bottom positions of the respective subsidiary frames, a motor for driving the chains, and a grip bar movable vertically, the opposite ends of the grip bar being supported on the both chains.

A preferred embodiment of the invention is described in detail below by referring to the accompanying drawings.

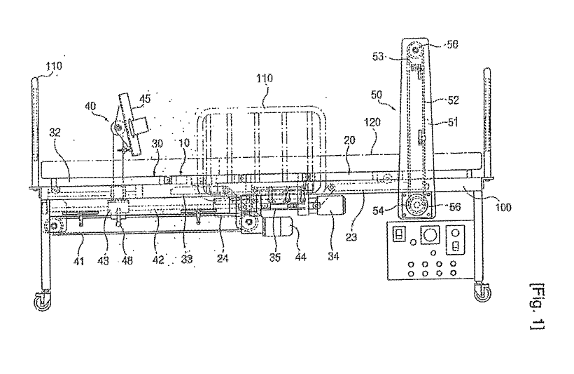

FIGS. 1 and 2 show respectively the front view and the plan view of a medical bed according to the invention.

As shown in FIGS. 1 and 2, the medical bed includes a rectangular frame 100 consisting of approximately 4 legs and a base part with a definite area, railings 110 disposed at the front and rear positions and the left and right positions and a mat 120 disposed on the frame, like an ordinary bed, and the medical bed has further features that the above-described frame or the frame plane is divided into three parts to cause the upper and lower bodies of a patient to move and the medical bed includes further a knee exercising device as well as an arm exercising device.

In the above-described construction, the frame comprises a fixed frame 10 taking a definite longitudinal middle position, and a frame for the upper body exercise 20 as well as a frame for the lower body exercise 30, these last frames taking the zones at the longitudinally front and rear positions of the fixed frame 10.

The above-described fixed frame 10 is the part to support the waist part of a patient and plays the supporting role so that the patient can balance himself or herself at the time of exercising.

The frame for the upper body part exercise 20 can turn or swing with respect to a shaft as the hinge, the shaft being contiguous to the fixed frame side, up to a certain inclined position or the straight lying position, so as to erect the upper body part of the patent.

The frame for the lower body exercise 30, which consists of two parts, can turn about the side contiguous to the fixed frame as a hinge and simultaneously can bend about an articulation or joint positioned longitudinally halfway. This frame acts to allow the patient to exercising the lower body, that is, to fold inward or unfold outward the legs about the patient's knee.

The knee exercising device 40 is erected to a certain height on a rear side (the side on which the feet are positioned) of the frame base and represents the part on which the feet of the patient are placed for the knee exercising, wherein a foot supporting stand for the knee exercising device can be reciprocated back and forth by a driving means installed under the frame.

The arm exercising device 50, which is located on the front side (the side on which the head rests), is the part which includes a grip bar, this bar being supported horizontally in the widthwise direction of the bed and being movable up and down to allow arm exercising, wherein the grip bar is fixed to circulating chains driven by a chain driving means located at the side of the frame to move up and down repeatedly.

The driving means for operating the sporting devices described above are all installed under the frame, and an operation panel to control the driving means is attached on a side near the frame, wherein on the operation panel, not only power switch and emergency switch, but also a timer switch for setting the exercising time, a speed adjusting switch for adjusting the exercising speed, an up/down switch for the upper body, an up/down switch for the lower body, a knee bending/stretching switch, an automatic switch etc. are disposed. A patient can enjoy a natural and comfortable exercising manually or automatically by appropriately selecting and operating those switches.

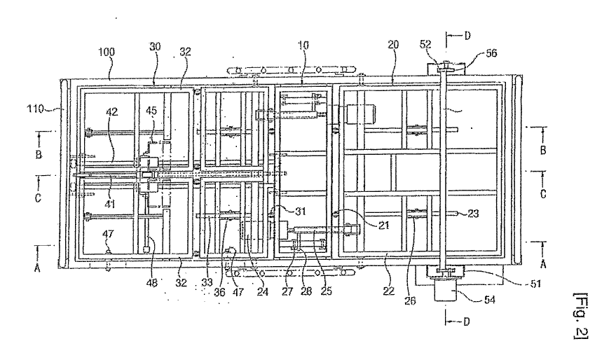

FIG. 3 shows the view for the structure and the operation of the frame for the upper body exercising through the cross section A-A of FIG. 2.

As shown in FIG. 3, a support frame 22 of the frame for the upper body exercising in the rectangular form of a definite area is disposed inside the contour of the frame and parallel to the frame and is possible to turn or fold about a hinge 21 contiguous to the fixed frame, wherein an actuating bar member 23 under the support frame 22 supports the latter transversely by an axial member to rotate together with the support frame.

The above-described actuating bar member 23, which acts to lift the support frame 22, includes an axial member extending along the width of the frame, two rod members extending rectangularly to the axial member and contacting the underside of the support frame 22, and two lever members extending shortly to the axial member and also having at a certain angle to the rod members, wherein the driving force to rotate the support frame 22 is received through the above-descried lever members.

Further, a motor 24 is disposed under the frame, wherein an actuating rod member 25 for transferring power in a screw method is connected between the shaft of the motor 24 and the lever member of the actuating bar member 23.

The actuating rod member 25 is composed of the combination of a screw member connected to the motor side and a cylinder member connected to the lever member side. When the screw member is rotated by the operation of the motor 24, the cylinder member conducts rectilinear motion to advance forward or backward due to the transmitting action of the screw.

That is, the regular or reverse rotation of the motor causes, for example, the extension or shortening of the length of the unengaged screw member up to the cylinder member.

Further, rollers 26 are mounted on the side of the support frame 22 at the contacting areas of the underside of the support frame 22 with the rod members, so that contacting may take place smoothly when the support frame 22 is erected or lowered.

In addition, two limit switches 27 at definite intervals are fixed on one side of the actuating rod member 25 whereas the cylinder member of the actuating rod member 25 is formed with a sensor rod 28 of a definite length perpendicularly toward the switches, whereby the overall length of the actuating rod member 25 including the exposed screw length can be extended or shortened or can be regulated within limits.

In other words, the rotation directions of the motor 25 can be changed in accordance with the signals of the sensor rod 28, installed on the cylinder member of the actuating rod member 25, when detecting the repeated contacts with two limit switches 27 so that the actuating rod member 25 can be extended or shortened only within the distance range detected through the limit switches 27.

Furthermore, the dynamic length of the actuating rod member 25 can be extended or shortened by changing the positional interval between the two limit switches 27 through a sloted-nut clamping mechanism provided on the frame.

Accordingly, the motion of raising or laying-down the upper part of the patient's body can be repeated by operating and setting the switches related with the upper body exercising on the control panel.

For instance, when the motor 24 is rotated in the regular direction with the actuation of the switch, the screw member of the actuating rod member 25 is rotated to cause the cylinder member to emerge forward so as to push the lever member of the actuating bar member 23, so that the actuating bar member 23 is turned upward with the axial member as the center to push up the underside of the support frame 22 or the rollers 26 through the rod members, with the result that the support frame 22 is turned upward accordingly with the hinge 21 positioned in the rear as the pivoting center to raise the frame front, whereby the patient can take the posture of positioning his or her upper part of the body upright while lying on the support frame.

The repeated changes of the rotation direction of the motor 24 cause the patient to take the exercising of raising and lowering his or her upper body repeatedly so as to bring about a natural sport of the upper body.

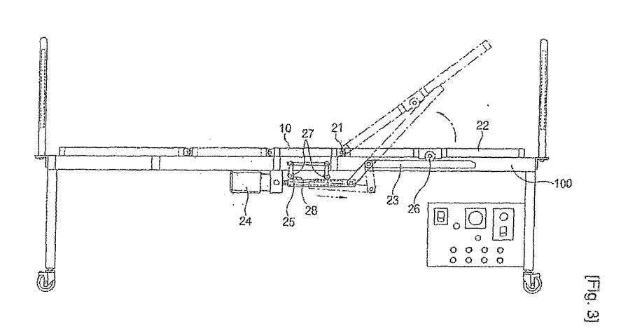

FIG. 4 shows the view for the structure and the operation of the frame for the lower body exercising through the cross section B-B of FIG. 2.

As shown in FIG. 4, a support frame 32 for supporting the lower body has about the same overall size as that of the support frame 22 of the frame for the upper body exercising 20 and is characterized in that this support frame 32 is foldable about the middle axis to compose two parts.

The support frame 32 is disposed inside the contour of the frame and parallel to the frame in a pivotal manner about a hinge 31 contiguous to the fixed frame and simultaneously is possible to turn i.e. fold or unfold about an articulation 39 positioned halfway, wherein an actuating bar member 33 under the front part of the support frame 32 supports the latter transversely by axial members to turn together with the front part of the frame.

Further, the rear part out of the two parts constituting the support frame 32 intended for the patient's feet portions is provided, at its rearmost bottom sites, with rollers, so as to render a smooth rolling motion, when the support frame is folded or unfolded around its middle axis.

The above-described actuating bar member 33, which acts to lift the support frame 32, includes an axial member extending along the width of the frame, two rod members extending rectangularly to the axial member and contacting the underside of the support frame 32, and two lever members extending shortly to the axial member and also having a certain angle to the rod members, wherein the driving force to rotate the support frame 32 is received through the above-descried lever members.

Further, a motor 34 is disposed under the frame, wherein an actuating rod member 35 for transmitting power in a screw method is connected between the shaft of the motor 34 and the lever member of the actuating bar member 33.

Similarly as in the case of the front frame as described above, the actuating rod member 35 is composed of the combination of a screw member connected to the motor side and a cylinder member connected to the lever member side. When the screw member is rotated by the operation of the motor 34, the cylinder member conducts a rectilinear motion to advance forward or backward due to the transmitting action of the screw.

That is, the regular or reverse rotation of the motor causes, for example, the extension or shortening of the overall length of the actuating rod unit.

The screw member of the actuating rod 35 is preferably supported by means of a separate bracket fixed to the motor side.

Further, rollers 36 are mounted on the side of the support frame 32 at the contacting areas of the underside of the support frame 32 with the rod members, so that contacting may take place smoothly without friction when the support frame 32 is erected or layed down.

In addition, two limit switches 37 at definite intervals are fixed at a nearby side of the actuating rod member 35 whereas the cylinder member of the actuating rod member 35 is provided with a sensor rod 38 of a definite length perpendicularly toward the switches, whereby the overall length of the actuating rod member 35 including the exposed screw length can be extended or shortened or can be regulated within limits.

In other words, the rotation directions of the motor 25 can be changed in accordance with the signals of the sensor rod 38, installed on the cylinder member of the actuating rod member 35, when detecting the repeated contacts with two limit switches 37 so that the actuating rod member 35 can be extended or shortened in the length only within the distance range detected through the limit switches 37.

Furthermore, the dynamic length of the actuating rod member 35 can be extended or shortened by changing the positional interval between the two limit switches 27 through a sloted-nut clamp mechanism provided on the frame.

Accordingly, the motion of folding or unfolding the lower part of the patient's body can be repeated by operating and setting the switches related with the lower body exercising on the control panel.

For instance, when the motor 34 is rotated in the regular direction with the actuation of the switch, the screw member of the actuating rod member 35 is rotated to cause the cylinder member to emerge outward so as to push the lever member of the actuating bar member 33, so that the actuating bar member 33 is turned upward with the axial member as the center to push up the underside of the support frame 32 for the thighs, having the rollers 36 mounted underside, through the rod members, with the result that the support frame 32 for the thighs is turned upward with the hinge 31 positioned in the rear as the pivoting center to raise the frame front, and at the same time, the support frame part 32 for the feet is slided forward, forming the symmetrical configuration with the frame for the thighs 32 through bending around the articulations 39, whereby the patient can be subjected to the exercising of folding and unfolding his or her lower body with the knees as the centers while lying on the support frame.

The repeated changes of the rotation direction of the motor 34 cause the patient to take the exercising of folding and raising or unfolding and lowering his or her lower body repeatedly so as to bring about a natural sport of the lower body.

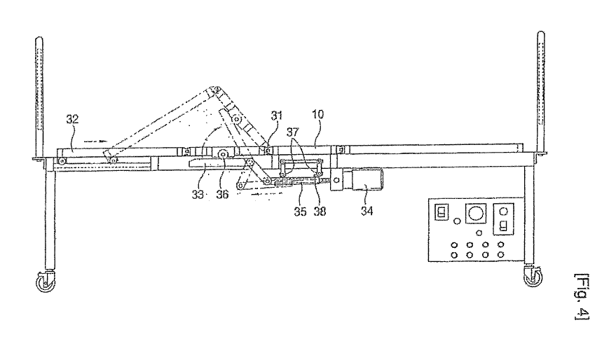

FIG. 5 shows the view for the structure and the operation of the knee exercising device through the cross section C-C of FIG. 2.

That is, FIG. 5 shows the knee exercising device 40 with which the patent can take exercising for knees while moving back and forth with the feet put on the parts of the device.

The knee exercising device 40 comprises roughly a feet resting stand 45 for resting the feet, a slider 43 for moving the feet resting stands 45 back and forth, chain 41 and a motor 44 for supplying power to the slider 43.

The feet resting stand 45 comprises a rectangular supporting board 45c of a definite area, the patient's soles being to touch this plate, a supporting body 45d contacting the supporting board 45c through a hinge shaft 54a at the rear central position of the supporting board and a supporting member 45e for supporting the feet put down on the supporting board 45c, wherein the supporting board 45c takes a slightly inclined pose relative to the vertical supporting body 45d, this inclination angle being adjustable by means of a bolt regulator 45b, and the supporting body 45d passes through the mat and the frame and then is detachably inserted in and clamped with the top part of the slider 43 disposed below.

Here, the mat and the frame are each provided with a long cutout of the widthwise middle stripe so as to allow the horizontal movement of the supporting body 45d.

The slider 43, which is fixed to the chain and so moves back and forth with the chain, is guided during movement by two parallel guide bars 42 disposed longitudinally in parallel to and under the frame.

In particular, the slider 43, the bottom side of which is connected to a side of the chain 41 by means of bolt clamp, is moved together with the chain when the latter is operated.

The chain 41 is disposed parallel to and in the longitudinal direction of the frame at the widthwise middle location of the frame, wherein the chain can be supported and circulated in a closed curve by sprockets 49, which are disposed rotatably through bearings at the opposite ends of the chain under the frame.

The above-described motor 44 as the part for driving the chain 41 supplies the power to the chain through a gear box 46.

In other words, the motor 44 and the gear box 46 are integrally assembled. The sprocket 49 for supporting one side of the chain 41 is connected to the side of the gear box 46, so that the torque of the motor 44 can be transmitted to the chain 41 through the gear box 46.

Further, the slider 43 can be regulated in its travelling distance or its stroke, as in the cases of the foregoing frames for lower and upper body exercising.

The interchangeability applicable to all body forms of patients is provided by this stroke regulation.

In addition, two limit switches 47 the span between which is variable are fixed on the frame, whereas a sensor rod 48 formed on one side of the slider 43 extends long horizontally, whereby the horizontal travel stroke of the sensor rod 48 can be detected by the respective limit switches 47 through contact detection method.

That is, the movement of the slider 43 is limited within the section bounded by the limit switches.

The regular or reverse rotation of the motor, for example, is changed in accordance with the detection signals of the limit switches 47, so that the slider 43 can be moved back and forth between the limit switches 47.

Furthermore, because the limit switches 47 can be mounted at varied locations through slotted-nuts provided on the frame, the stroke of the slider 43 can be adjusted to meet the physical form of a patient by adjusting the interval between the two limit switches 47.

Accordingly, the exercising of folding or stretching the knees of the patient can be conducted repeatedly by operating and setting the switches related with the knee exercising on the control panel.

For instance, when the motor 44 is rotated in the regular direction with the actuation of the switch, with the patient's feet touched on the feet resting stand 45 (either touched directly or hung by using a separate belt), the chain 41 between the both sprockets 49 is moved clockwise and simultaneously the slider 43 and the foot supporting stand 45 are also moved forward, so that the patient will be subjected to bending of his or her knees with the feet pulled forward while lying on the mat.

The repeated changes of the rotation direction of the motor 44 cause the patient to take the exercising of folding and stretching his or her upper body repeatedly so as to bring about a natural sport of the knee part.

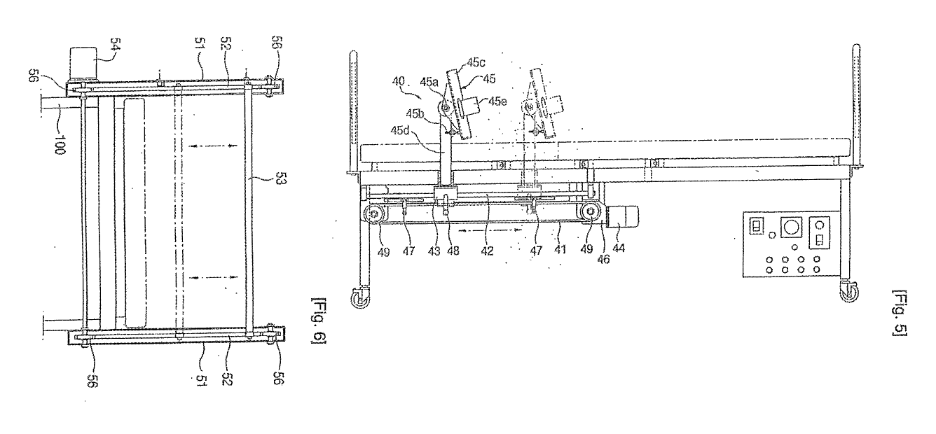

FIG. 6 shows the view for the structure and the operation of the arm exercising device through the cross section D-D of FIG. 2.

As shown in FIG. 6, the arm exercising device is based on the operating manner of naturally raising and lowering the arms of a patient while the patient lies.

Thus, two subsidiary frames 51 are erected on opposite front ends of the frame base, and a chain driving means including a motor, required for the arm exercise, and a grip bar 53 supported on the chain for a vertical movement and the like are provided to perform the required exercising function in conjunction with the use of the subsidiary frames 51.

In other words, sprockets 56 are respectively disposed at the top and bottom sites inside each subsidiary frame 51, chains 52 in the closed form are vertically hung on the upper and lower sprockets 56 on respective sides, and a motor 54 is disposed in use of a subsidiary frame 51 at a side of a sprocket 56, the motor being connected to the sprocket 56, in order to use the chains 52. The grip bar 53, the both ends of which are supported on the both chains 52, is moved up and down in accordance with the motion of the chains 52. The vertical movement of the grip bar 53 may be limited as in the foregoing by installing a sensor rod on a chain and installing limiting switches at an upper and lower position of a subsidiary frame in such a way as to adjust the interval between the two limiting switches.

Accordingly, the patient can take the exercise of repeatedly folding and stretching the arms by setting and operating the switches related to the arm exercise with his or her hands holding the grip bar 53, maintaining the posture of lying down.

The natural sport for the arms can be conducted, because the chains 52 connected to the sprockets 56 are moved up and down at the rotation of the motor 54 so as to pull and push the grip bar 53 supported on the chains 52 to thereby cause the bending and stretching of the arms.

### INDUSTRIAL APPLICABILITY

As described in the above, the present invention has the advantage that a rehabilitation patient can do rehabilitation sport even on the bed and a general patient can maintain and improve the basic physical strength and the health, by providing a medical bed with a means, with which the patient can naturally conduct the exercise for the upper and lower parts of the body, the legs, the arms etc. alone on the bed.

1. A medical bed with an exercising means including railings disposed at the front and rear as well as the left and right positions, a frame and a mat on the frame, wherein the frame comprises a fixed frame 10 taking a predetermined longitudinal middle position, a frame for the upper body exercise 20 taking the position ahead of the fixed frame, this frame being able to erect and lie around a hinge by a driving means, and a frame for the lower body exercise 30 taking the position behind the fixed frame, this frame being able to fold and unfold around a hinge and again around a midway articulation by a driving means.

2. A medical bed with an exercising means of claim 1, wherein the frame for the upper body exercise 20 comprises a support frame 22 in the rectangular form turnable around a hinge 21 on one side, the frame having a prescribed area, an actuating bar member 23 disposed under the support frame and rotatable through an axial member in contact with the frame, the actuating bar member lifting the support frame through rod members in tight contact with the underside of the support frame, an actuating rod member 25 based on the screw for pulling and pushing the actuating bar member by extending and shortening its length, the actuating rod member being connected to the axial member of the actuating bar member through a hinge on one side and connected to the shaft of the motor on the other side, and a motor 24 hinge-supported on the frame, the motor being connected to the screw of the actuating rod member.

3. A medical bed with an exercising means of claim 2, wherein the above support frame 22 includes further rollers 26 mounted on the areas in contact with the rod members of the actuating bar member 23.

4. A medical bed with an exercising means of claim 2, wherein the actuating rod member 25 is regulatable to extend or shorten by two limit switches 27 fixed on the frame, the interval between the two limit switches being variable, and a sensor rod 28 formed on the cylinder of the actuating rod member, the sensor rod being to contact the limit switches 27.

5. A medical bed with an exercising means of claim 1, wherein the frame for the lower body exercise 30 comprises a support frame 32 in the combined rectangular form having a certain area, the support frame being rotatable and foldable or stretchable around a hinge 31 on one side and around a halfway articulation, an actuating bar member 33 disposed under the support frame and rotatable through an axial member in contact with the frame, the actuating bar member lifting the support frame through rod members 32 in tight contact with the underside of the support frame, an actuating rod member 35 based on the screw for pulling and pushing the actuating bar member by extending and shortening its length, the actuating rod member being connected to the axial member of the actuating bar member through a hinge on one side and connected to the shaft of the motor on the other side, and a motor 34 hinge-supported on the frame, the motor being connected to the screw of the actuating rod member.

6. A medical bed with an exercising means of claim 5, wherein the above support frame 32 includes further rollers 36 mounted on the areas in contact with the rod members of the actuating bar member 33.

7. A medical bed with an exercising means of claim 5, wherein the actuating rod member 35 is regulatable to extend or shorten by two limit switches 37 fixed on the frame, the interval between the two limit switches being variable, and a sens or rod formed on the cylinder of the actuating rod member, the sensor rod 38 being to contact the limit switches 37.

8. A medical bed with an exercising means of claim 1, wherein the frame preferably comprises a knee exercising device 40 having chain 41 disposed longitudinally under the frame and a motor 44 for driving the chain, a slider 43 movable back and forth under the guidance of two parallel guide bars 42, the bottom of the slider 43 being connected to the chain, and a feet resting rest 45 positioned to a prescribed height above the frame and movable back and forth, the feet resting rest 45 passing through the frame to combine detachably with the underlying slider.

9. A medical bed with an exercising means of claim 8, wherein the feet resting rest 45 comprises a supporting board 45c connected to a supporting body 45d through a hinge 45c and also connected to a supporting body 45d through a bolt regulator 45b so as to be able to adjust the inclination angle of the board, the patient's feet being to be put on the board, and a supporting body 45d connected to the side of the slider 43.

10. A medical bed with an exercising means of claim 8, wherein the knee exercising device 40 is regulatable in its stroke of moving back and forth by two limit switches 47 fixed on the frame, the interval between the two limit switches 47 being variable, and a sensor rod 48 formed on the side of the slider 43, the sensor rod 48 being to contact the limit switches 47.

11. A medical bed with an exercising means of claim 1, wherein the above-described frame comprises the arm exercising device having two subsidiary frames 51 erected vertically on opposite front ends of the frame, two chains 52 disposed parallel vertically and combined to the sprockets 56, the sprockets mounted on the top and bottom positions of the respective subsidiary frames 51, a motor 64 for driving the chains 52, and a grip bar 53 movable vertically, the opposite ends of the grip bar being supported on the both chains 52.
